(19) United States
(12) Patent Application Publication
(10) Pub. No.: US 2026/0302189 A1
(43) Pub. Date: Oct. 1, 2026

(54) NEGATIVE ELECTRODE FOR NON-AQUEOUS ELECTROLYTE SECONDARY BATTERY

(71) Applicant: TOYOTA JIDOSHA KABUSHIKI KAISHA, Toyota-shi (JP)

(72) Inventor: Daiki MAEDA, Toyota-shi (JP)

(73) Assignee: TOYOTA JIDOSHA KABUSHIKI KAISHA, Toyota-shi (JP)

(21) Appl. No.: 19/560,358

(22) Filed: Mar. 9, 2026

(30) Foreign Application Priority Data
Mar. 28, 2025 (JP) 2025-055369

(51) Int. Cl. H01M 4/36; H01M 4/02; H01M 4/133; H01M 4/134; H01M 4/38; H01M 4/583; H01M 4/62

(52) U.S. Cl. CPC H01M 4/366; H01M 4/133; H01M 4/134; H01M 4/364; H01M 4/386; H01M 4/583; H01M 4/622; H01M 2004/027

(57) ABSTRACT

A negative electrode for a non-aqueous electrolyte secondary battery includes a negative electrode collector and a negative electrode active material layer. The negative electrode active material layer is disposed on a surface of the negative electrode collector. The negative electrode active material layer includes a first layer and a second layer. The first layer is disposed between the negative electrode collector and the second layer. The negative electrode active material layer contains artificial graphite, natural graphite, and a Si-based active material as a negative electrode active material. A mass fraction of the artificial graphite in the first layer is higher than that in the second layer. A mass fraction of the natural graphite in the first layer is lower than that in the second layer. A mass fraction of the Si-based active material in the first layer is higher than that in the second layer.

### CROSS-REFERENCE TO RELATED APPLICATION

This application claims priority to Japanese Patent Application No. 2025-055369 filed on Mar. 28, 2025. The disclosure of the above-identified application, including the specification, drawings, and claims, is incorporated by reference herein in its entirety.

### BACKGROUND

### 1. Technical Field

The present disclosure relates to a negative electrode for a non-aqueous electrolyte secondary battery.

### 2. Description of Related Art

Japanese Unexamined Patent Application Publication No. 2009-064574 (JP 2009-064574 A) discloses a multilayer structure in which a first negative electrode layer on a side close to a negative electrode collector has artificial graphite and a second negative electrode layer on a side far from the negative electrode collector has natural graphite.

### SUMMARY

Hereinafter, the “negative electrode for a non-aqueous electrolyte secondary battery” may be abbreviated as “negative electrode”. A negative electrode having a multilayer structure is proposed. For example, it is proposed to dispose artificial graphite in a lower layer on a side close to the negative electrode collector and to dispose natural graphite in an upper layer on a side far from the negative electrode collector. By disposing the natural graphite having relatively favorable charge rate characteristics on a side close to a positive electrode, an improvement in charge rate characteristics is expected. However, there is room for improvement in energy density and expansion.

An object of the present disclosure is to increase an energy density and charge rate characteristics of a negative electrode and to reduce expansion of the negative electrode.

Hereinafter, technical configurations and effects of the present disclosure will be described. However, a mechanism of action includes an estimation. The mechanism of action does not limit the technical scope of the present disclosure.

1. A negative electrode for a non-aqueous electrolyte secondary battery according to one aspect of the present disclosure includes: a negative electrode collector; and a negative electrode active material layer.
The negative electrode active material layer is disposed on a surface of the negative electrode collector.
The negative electrode active material layer includes a first layer and a second layer.
The first layer is disposed between the negative electrode collector and the second layer.
The negative electrode active material layer contains artificial graphite, natural graphite, and a Si-based active material as a negative electrode active material.
A mass fraction of the artificial graphite in the first layer is higher than a mass fraction of the artificial graphite in the second layer.
A mass fraction of the natural graphite in the first layer is lower than a mass fraction of the natural graphite in the second layer.
A mass fraction of the Si-based active material in the first layer is higher than a mass fraction of the Si-based active material in the second layer.

In order to increase the energy density, the use of the Si-based active material is considered. However, the Si-based active material may significantly expand during charging. The negative electrode active material layer may collapse because it does not withstand the expansion of the Si-based active material. With the introduction of the Si-based active material, a measure against the expansion is also demanded. For example, in order to increase the energy density while alleviating the expansion, it is considered to mix a carbon-based active material (artificial graphite, natural graphite) and the Si-based active material.

FIG. 1 is a conceptual cross-sectional view showing a first multilayer structure. In the drawings of the present disclosure, “NG” indicates natural graphite. “AG” indicates artificial graphite. “Si” indicates the Si-based active material. The negative electrode includes a negative electrode collector 21 and a negative electrode active material layer 22. The negative electrode active material layer 22 has a multilayer structure. In the multilayer structure for improving the charge rate characteristics, the artificial graphite may be disposed in the first layer 1 (lower layer), and the natural graphite may be disposed in the second layer 2 (upper layer).

FIG. 2 is a conceptual cross-sectional view showing a second multilayer structure. In order to increase the energy density while maintaining the charge rate characteristics in the first laminated structure (FIG. 1), in the second laminated structure (FIG. 2), the Si-based active material is uniformly mixed in the first layer 1 and the second layer 2. However, in the second multilayer structure, the network of the natural graphite may be broken by the expansion of the Si-based active material in the second layer 2. As a result, desired charge rate characteristics may not be obtained.

FIG. 3 is a conceptual cross-sectional view showing a third multilayer structure. In order to increase the energy density while maintaining the charge rate characteristics in the first laminated structure (FIG. 1), in the third laminated structure (FIG. 3), the natural graphite is disposed in the second layer 2 (upper layer), and the Si-based active material is disposed in the first layer 1 (lower layer). In the third multilayer structure, the expansion of the Si-based active material in the thickness direction may be alleviated. It is considered that the natural graphite absorbs the expansion of the Si-based active material. However, since the expansion of the Si-based active material in the in-plane direction is severe, the laminated structure may not be maintained. The “in-plane direction” indicates any direction orthogonal to the thickness direction (Z-axis direction). The X-axis direction and the Y-axis direction are examples of the in-plane direction.

FIG. 4 is a conceptual cross-sectional view showing a fourth multilayer structure. The fourth laminated structure (FIG. 4) is obtained by replacing the second layer 2 (upper layer) in the third laminated structure (FIG. 3) with the artificial graphite. In the fourth laminated structure (FIG. 4), the charge rate characteristics are not expected, but the expansion of the Si-based active material can be alleviated. However, according to new findings of the present disclosure, the artificial graphite tends to be difficult to absorb the expansion of the Si-based active material in the thickness direction. The fourth laminated structure (FIG. 4) may have a larger expansion amount than the third laminated structure (FIG. 3).

FIG. 5 is a conceptual cross-sectional view showing a fifth multilayer structure. The fifth laminated structure (FIG. 5) is obtained by making the Si-based active material unevenly distributed in the first layer 1 (lower layer) in the second laminated structure (FIG. 2). In the fifth laminated structure, the natural graphite is unevenly distributed in the second layer 2 (upper layer), so that desired charge rate characteristics are expected. Furthermore, according to new findings of the present disclosure, the natural graphite tends to easily absorb the expansion of the Si-based active material in the thickness direction, and the artificial graphite tends to easily absorb the expansion of the Si-based active material in the in-plane direction. Therefore, the Si-based active material in the first layer 1 (lower layer) may synergistically absorb the expansion in both the thickness direction and the in-plane direction. Therefore, in the fifth laminated structure, a negative electrode having high energy density and charge rate characteristics and reduced expansion is expected to be provided.

2. The negative electrode according to the “1” may include, for example, the following configuration.
The negative electrode active material layer further contains a binder.
A mass fraction of the binder in the first layer is higher than a mass fraction of the binder in the second layer.

In the first layer (lower layer), the mass fraction of the binder is relatively high, so that structural destruction due to the expansion of the Si-based active material may be suppressed. In the second layer (upper layer), the mass fraction of the binder is relatively low, so that an improvement in charge rate characteristics is expected.

3. The negative electrode according to the “1” or the “2” may include, for example, the following configuration.
The negative electrode active material layer further contains a binder layer.
The binder layer is disposed between the first layer and the second layer.
A mass fraction of the binder in the binder layer is higher than a mass fraction of the binder in the first layer and the second layer.

The Si-based active material is unevenly distributed in the first layer (lower layer), so that a difference in expansion amount may occur between the first layer and the second layer. Mismatch in expansion amount between the layers may also cause interlayer peeling. It is expected that the binder layer interposed between the first layer and the second layer absorbs the mismatch in expansion amount and suppresses interlayer peeling.

4. The negative electrode according to any one of the “1” to the “3” may include, for example, the following configuration.
A void ratio of the first layer is higher than a void ratio of the second layer.

The void ratio of the first layer is relatively high, so that the expansion is expected to be reduced. It is considered that a void may absorb the expansion of the Si-based active material. The void ratio of the second layer is relatively low, so that an improvement in charge rate characteristics is expected.

5. A negative electrode for a non-aqueous electrolyte secondary battery according to one aspect of the present disclosure includes: a negative electrode collector; and a negative electrode active material layer.
The negative electrode active material layer is disposed on a surface of the negative electrode collector.
The negative electrode active material layer includes a first layer, a second layer, and a binder layer.
The first layer is disposed between the negative electrode collector and the second layer.
The negative electrode active material layer contains a negative electrode active material and a binder.
The negative electrode active material in the first layer consists of substantially artificial graphite and a Si-based active material.
The negative electrode active material in the second layer consists of substantially natural graphite.
The natural graphite has a larger aspect ratio than the artificial graphite.
A void ratio of the first layer is higher than a void ratio of the second layer.
A mass fraction of the binder in the first layer is higher than a mass fraction of the binder in the second layer.
The binder layer is disposed between the first layer and the second layer.
A mass fraction of the binder in the binder layer is higher than a mass fraction of the binder in the first layer and the second layer.

Hereinafter, an embodiment of the present disclosure (hereinbelow, may be abbreviated as “the present embodiment”) will be described. However, the present embodiments and the present examples do not limit the technical scope of the present disclosure. The present embodiments and the present examples are illustrative in all respects. The present embodiments and the present examples are non-restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual cross-sectional view showing a first multilayer structure;

FIG. 2 is a conceptual cross-sectional view showing a second multilayer structure;

FIG. 3 is a conceptual cross-sectional view showing a third multilayer structure;

FIG. 4 is a conceptual cross-sectional view showing a fourth multilayer structure;

FIG. 5 is a conceptual cross-sectional view showing a fifth multilayer structure;

FIG. 6 is a conceptual diagram showing an example of a non-aqueous electrolyte secondary battery in the present embodiment; and

FIG. 7 is a conceptual cross-sectional view for describing an alignment angle.

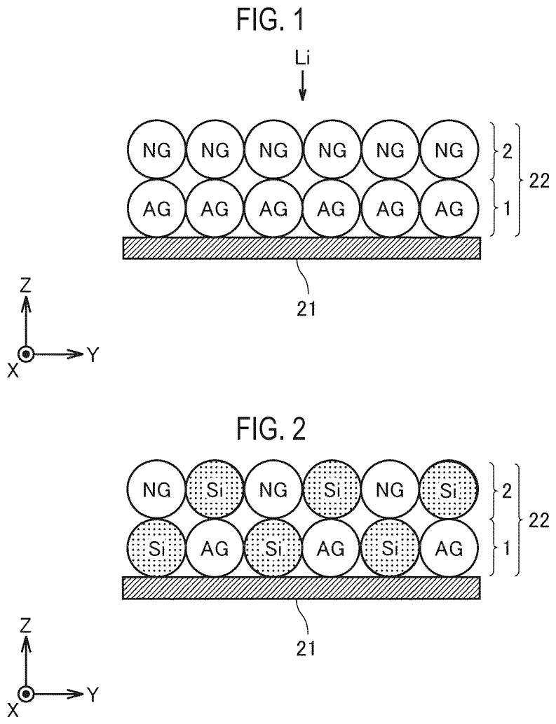

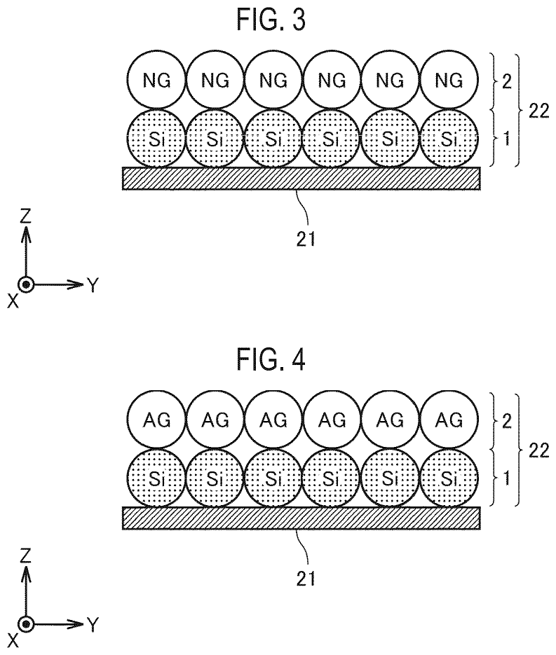

### DETAILED DESCRIPTION OF EMBODIMENTS

### Terms and Phrases

The terms “comprising”, “including”, “having”, and their modifications are open-ended expressions. A configuration expressed in an open-ended manner may further include or may not include an additional element in addition to the essential element. The description of “consisting of” is a closed-ended expression. However, even in a configuration expressed in a closed-ended manner, an additional element that is usually an impurity or is irrelevant to the target technology may be included. The description of “substantially consisting of” is a semi-closed-ended expression. In a configuration expressed in a semi-closed-ended manner, addition of an element that does not substantially affect the basic and novel characteristics of the target technology is allowed.

Geometric terms should not be construed in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include a tolerance, an error, or the like in design, operation, manufacturing, or the like. The dimensional relationships in each drawing sometimes do not agree with the actual dimensional relationships. For the understanding of the reader, the dimensional relationship in each drawing may be changed. For example, a length, a width, and a thickness may be changed. Some configurations may be omitted.

The “artificial graphite” indicates graphite synthesized by artificial heat treatment. The artificial graphite is also referred to as synthetic graphite (SD). The “natural graphite” indicates graphite generated in nature. The natural graphite includes flake graphite. The flake graphite may be rounded so that an end of the particle is bent. The natural graphite may be coated with, for example, amorphous carbon. The “Si-based active material” contains Si (or a Si compound, a Si alloy, or the like) that can be alloyed with Li. The Si-based active material may include, for example, at least one selected from the group consisting of pure Si, a Si-based alloy, SiO, and Si—C. The “Si—C” indicates a composite particle containing Si (or SiO) and carbon. For example, Si may be supported on the carbon material.

The “particle diameter” is specified by a microscope method. The particle diameter indicates an arithmetic average of a long side and a short side in a minimum bounding rectangle (MBR) of a two-dimensional image of the particle. The “average particle diameter” indicates an arithmetic average of 100 particle diameters. Various image analyses in the present embodiment may be performed by software. For example, “ImageJ” may be used.

The “aspect ratio” indicates a ratio of the long side to the short side of the MBR. An arithmetic average of 100 aspect ratios is adopted.

The “basis weight” indicates a mass per unit area.

The “void ratio” is specified by an image analysis method. The void and the solid are discriminated by binarizing a cross-sectional scanning electron microscope (SEM) image of each layer. The void ratio is obtained by dividing the total area (total pixels) of the voids by the area of the entire layer.

### Non-Aqueous Electrolyte Secondary Battery

FIG. 6 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a metal container, a pouch made of an aluminum laminate film. The power generation element 50 may include, for example, a positive electrode 10, a negative electrode 20, a separator 30, and a non-aqueous electrolyte (not shown). The power generation element 50 may be, for example, a wound type or a laminated type. The power generation element 50 may have a monopolar structure or a bipolar structure. The separator 30 may electrically separate the positive electrode 10 from the negative electrode 20. The separator 30 may include, for example, a porous film made of a resin. The non-aqueous electrolyte is a Li ion conductor. The non-aqueous electrolyte may include, for example, a Li salt and an organic solvent. The non-aqueous electrolyte may be, for example, impregnated in the separator 30. The non-aqueous electrolyte may include, for example, a gel electrolyte, and a solid electrolyte (an oxide solid electrolyte and a sulfide solid electrolyte). The positive electrode 10 contains a positive electrode active material. The positive electrode active material may include, for example, a lithium transition metal composite oxide (Li[NiCoMn]O₂) and a lithium phosphate compound (Li[FeMn]PO₄). The description of [NiCoMn], [FeMn], and the like indicates that the total of the compositional ratios of the components in [ ] is “1”. The compositional ratio of each component is optional as long as the total is 1. For example, the compositional ratio of some components may be zero.

### Negative Electrode

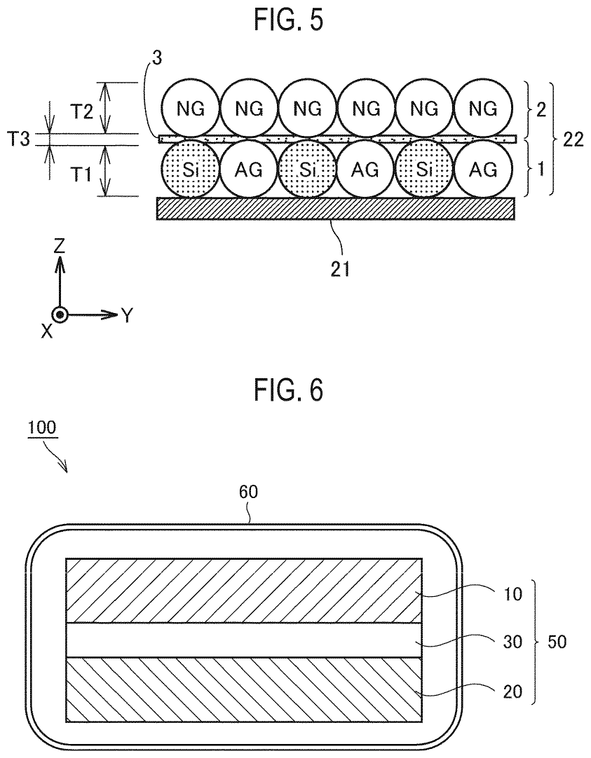

The negative electrode 20 may have a sheet-like shape, for example. As shown in FIG. 5, the negative electrode 20 includes a negative electrode collector 21 and a negative electrode active material layer 22. The negative electrode active material layer 22 is disposed on a surface of the negative electrode collector 21. The negative electrode active material layer 22 may be disposed on a part of the surface of the negative electrode collector 21 or may be disposed on the entire surface. The negative electrode active material layer 22 may be disposed on only one surface of the negative electrode collector 21 or may be disposed on both surfaces of the negative electrode collector 21. The negative electrode collector 21 may include, for example, a metal foil (a Cu foil, a Ni foil, or the like), and a conductive resin layer. The negative electrode collector 21 may have a thickness of, for example, 1 μm to 100 μm.

### Negative Electrode Active Material Layer

The negative electrode active material layer 22 has a multilayer structure. The negative electrode active material layer 22 includes the first layer 1 and the second layer 2. The negative electrode active material layer 22 may further include any layer as long as the first layer 1 and the second layer 2 are included. For example, a binder layer 3 (described later) or the like may be disposed between the first layer 1 and the second layer 2. For example, a conductive layer, an adhesion layer (both not shown), or the like may be disposed between the first layer 1 and the negative electrode collector 21. For example, a ceramic particle layer or the like (not shown) may be disposed on a surface of the second layer 2. The ceramic particle layer may include, for example, a heat-resistant ceramic (alumina and boehmite).

Each layer included in the negative electrode active material layer 22 may be, for example, a coating layer. The coating layer indicates a layer formed by applying a coating material. Each coating material may be applied substantially simultaneously or may be applied in sequence.

The first layer 1 is disposed between the negative electrode collector 21 and the second layer 2. The first layer 1 may be directly formed on the surface of the negative electrode collector 21. The second layer 2 may form, for example, a surface layer of the negative electrode active material layer 22. The second layer 2 may be directly formed on the surface of the first layer 1.

Each layer may have any thickness. For example, the thickness of the first layer 1 is “T₁”, and the thickness of the second layer 2 is “T₂”. In this case, “T₁” and “T₂” may satisfy relationships such as “T₁/T₂=1/9 to 9/1”, “T₁/T₂=2/8 to 8/2”, “T₁/T₂=3/7 to 7/3”, and “T₁/T₂=4/6 to 6/4”. The thickness “T₁” may be, for example, 10 μm or more, 50 μm or more, 100 μm or more, 200 μm or more, or 500 μm or more. The thickness “T₁” may be, for example, 1 mm or less, 500 μm or less, or 200 μm or less.

Each layer may have any basis weight. For example, the basis weight of the first layer 1 is “W₁”, and the basis weight of the second layer 2 is “W₂”. In this case, “W₁” and “W₂” may satisfy relationships such as “W₁/W₂=1/9 to 9/1”, “W₁/W₂=2/8 to 8/2”, “W₁/W₂=3/7 to 7/3”, and “W₁/W₂=4/6 to 6/4”. The basis weight “W₁” may be, for example, 1 mg/cm² or more, 5 mg/cm² or more, 10 mg/cm² or more, or 20 mg/cm² or more. The basis weight “W₁” may be, for example, 50 mg/cm² or less, 30 mg/cm² or less, 25 mg/cm² or less, 15 mg/cm² or less, or 10 mg/cm² or less.

The void ratio of the negative electrode active material layer 22 may be substantially constant over the entire region. The void ratio may be locally different. For example, the void ratio “φ₁” of the first layer 1 may be higher than the void ratio “φ₂” of the second layer 2. That is, a relationship of “φ₂<φ₁” or “1 <φ₁/φ₂” may be satisfied. The ratio “φ₁/φ₂” may be, for example, 1.2 or more, 1.5 or more, 2 or more, or 2.5 or more. The ratio “φ₁/φ₂” may be, for example, 5 or less, 3 or less, or 2 or less.

### Negative Electrode Active Material

The negative electrode active material layer 22 contains a negative electrode active material. The negative electrode active material layer 22 may further include, for example, a conductive material and a binder. The negative electrode active material layer 22 may include, for example, in terms of mass fraction, 0% to 10% of a binder, 0% to 10% of a conductive material, and the remaining negative electrode active material. The negative electrode active material layer 22 may include, for example, in terms of mass fraction, 0.1% to 3% of a binder, 0% to 3% of a conductive material, and the remaining negative electrode active material. The negative electrode active material layer 22 may include, for example, in terms of mass fraction, 0.5% to 2% of a binder, 0.5% to 2% of a conductive material, and the remaining negative electrode active material.

The negative electrode active material includes artificial graphite, natural graphite, and a Si-based active material. The negative electrode active material may further include an active material other than the artificial graphite, the natural graphite, and the Si-based active material. The other active material may include, for example, lithium titanate, a Sn-based alloy, SnO, pure Li, and a Li-based alloy.

The artificial graphite is unevenly distributed in the first layer 1. A mass fraction “M_{1A}” of the artificial graphite in the first layer 1 is higher than a mass fraction “M_{2A}” of the artificial graphite in the second layer 2. That is, a relationship of “M_{2A}<M_{1A}” or “1<M_{1A}/M_{2A}” is satisfied. The ratio “M_{1A}/M_{2A}” may be, for example, 1.5 or more, 2 or more, 3 or more, 5 or more, 10 or more, 50 or more, or 100 or more. The ratio “M_{1A}/M_{2A}” may be, for example, 1000 or less or 100 or less. The mass fraction “M_{1A}” may be, for example, 40% or more, 50% or more, 60% or more, 70% or more, 80% or more, 90% or more, 95% or more, 98% or more, or 99% or more. The mass fraction “M_{1A}” may be, for example, 100% or less, 99% or less, 98% or less, or 95% or less.

The natural graphite is unevenly distributed in the second layer 2. A mass fraction “M_{1N}” of the natural graphite in the first layer 1 is lower than a mass fraction “M_{2N}” of the natural graphite in the second layer 2. That is, a relationship of “M_{1N}<M_{2N}” or “M_{1N}/M_{2N}<1” is satisfied. The ratio “M_{1N}/M_{2N}” may be, for example, 0.9 or less, 0.5 or less, 0.3 or less, 0.1 or less, or 0.01 or less. The ratio “M_{1N}/M_{2N}” may be, for example, 0 or more, 0.001 or more, 0.01 or more, or 0.1 or more. The mass fraction “M_{2N}” may be, for example, 40% or more, 50% or more, 60% or more, 70% or more, 80% or more, 90% or more, 95% or more, 98% or more, or 99% or more. The mass fraction “M_{2N}” may be, for example, 100% or less, 99% or less, 98% or less, or 95% or less.

The Si-based active material is unevenly distributed in the first layer 1. A mass fraction “M_{1S}” of the Si-based active material in the first layer 1 is higher than a mass fraction “M_{2S}” of the Si-based active material in the second layer 2. That is, a relationship of “M_{2S}<M_{1S}” or “1<M_{1S}/M_{2S}” is satisfied. The ratio “M_{1S}/M_{2S}” may be, for example, 1.5 or more, 2 or more, 3 or more, 5 or more, 10 or more, 50 or more, or 100 or more. The ratio “M_{1S}/M_{2S}” may be, for example, 1000 or less or 100 or less. The mass fraction “M_{1S}” may be, for example, 3% or more, 5% or more, 10% or more, 20% or more, 30% or more, 40% or more, 50% or more, 60% or more, 70% or more, 80% or more, 90% or more, 95% or more, 98% or more, or 99% or more. The mass fraction “M_{1S}” may be, for example, 100% or less, 99% or less, 98% or less, 95% or less, 90% or less, 80% or less, 70% or less, 60% or less, 50% or less, 40% or less, 30% or less, 20% or less, 10% or less, or 5% or less.

As described above, the first layer 1 and the second layer 2 may each independently include the artificial graphite, the natural graphite, and the Si-based active material as long as the relationships of “M_{2A}<M_{1A}”, “M_{1N}<M_{2N}”, and “M_{2S}<M_{1S}” are satisfied. For example, the negative electrode active material in the first layer 1 may consist of substantially the artificial graphite and the Si-based active material. For example, the negative electrode active material in the second layer 2 may consist of substantially the natural graphite.

For example, in the first layer 1, the mass fraction of the artificial graphite is “M_{1A}”, and the mass fraction of the Si-based active material is “M_{1S}”. In this case, “M_{1A}” and “M_{1S}” may satisfy relationships such as “M_{1A}/M_{1S}=1/9 to 9/1”, “M_{1A}/M_{1S}=2/8 to 8/2”, “M_{1A}/M_{1S}=3/7 to 7/3”, and “M_{1A}/M_{1S}=4/6 to 6/4”.

The average particle diameter “d_{A}” of the artificial graphite, the average particle diameter “d_{N}” of the natural graphite, and the average particle diameter “d_{S}” of the Si-based active material may each independently take any value. For example, a relationship of “d_{S}<d_{A}” may be satisfied. The ratio “d_{S}/d_{A}” may be, for example, 0.8 or less, 0.6 or less, 0.4 or less, or 0.2 or less. The ratio “d_{S}/d_{A}” may be, for example, 0.1 or more. The ratio “d_{A}/d_{N}” may be, for example, 0.5 or more, 1 or more, or 2 or more. The ratio “d_{A}/d_{N}” may be, for example, 2 or less, 1 or less, or 0.5 or less. The average particle diameter “d_{A}” may be, for example, 1 μm or more, 5 μm or more, 10 μm or more, 15 μm or more, or 20 μm or more. The average particle diameter “d_{A}” may be, for example, 30 μm or less, 25 μm or less, 20 μm or less, or 15 μm or less.

The artificial graphite, the natural graphite, and the Si-based active material may each independently have any particle shape. The particle shape may be, for example, spherical, ellipsoidal, or flat. For example, an aspect ratio “R_{N}” of the natural graphite may be larger than an aspect ratio “R_{A}” of the artificial graphite. For example, a relationship of “1<R_{N}/R_{A} ≤5” or the like may be satisfied. The aspect ratio “R_{N}” of the natural graphite may be, for example, 1.5 or more, 2 or more, or 3 or more. The aspect ratio “R_{N}” of the natural graphite may be, for example, 5 or less. The aspect ratio “R_{A}” of the artificial graphite may be, for example, less than 1.5, 1.4 or less, 1.3 or less, 1.2 or less, or 1.1 or less. The aspect ratio “R_{A}” of the artificial graphite may be, for example, 1 or more.

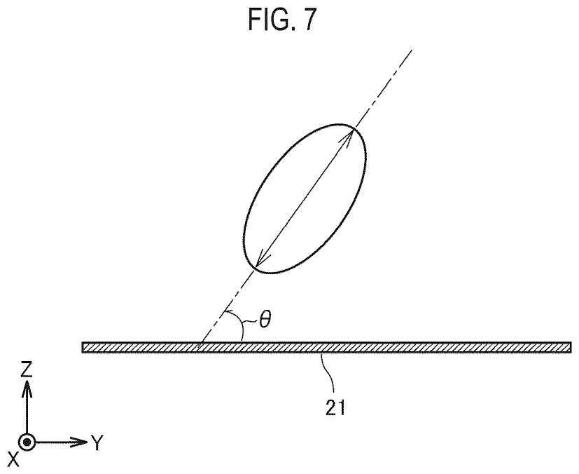

In a case where the natural graphite has an aspect ratio of more than 1, the natural graphite in the second layer 2 may be aligned in the in-plane direction (lateral direction). It is expected that the expansion of the Si-based active material included in the first layer 1 is easily absorbed by the alignment of the natural graphite in the second layer 2 in the in-plane direction. The degree of alignment may be evaluated by an alignment angle “θ”. FIG. 7 is a conceptual cross-sectional view for describing an alignment angle. The alignment angle “θ” is an angle (acute angle) between a major axis “L” of the natural graphite (particle) and the surface of the negative electrode collector 21 in a cross-sectional SEM image of the negative electrode 20. The major axis is an extension line of the maximum Feret diameter of the particle. The smaller the alignment angle “θ”, the more the particles may be evaluated to be aligned in the lateral direction. The alignment angle “θ” may be, for example, 45° or less, 30° or less, 15° or less, or 5° or less. The alignment angle “θ” may be, for example, 0° or more, 1° or more, or 3° or more.

### Binder

The binder may include, for example, styrene butadiene rubber (SBR), carboxymethyl cellulose (CMC), polyacrylic acid (PAA), and polytetrafluoroethylene (PTFE). The mass fraction of the binder may be substantially constant over the entire region of the negative electrode active material layer 22. The mass fraction of the binder may be locally different. For example, the mass fraction of the binder may be different between the first layer 1 and the second layer 2. For example, a mass fraction “M_{1B}” of the binder in the first layer 1 may be higher than a mass fraction “M_{2B}” of the binder in the second layer 2. That is, a relationship of “M_{2B}<M_{1B}” or “1 <M_{1B}/M_{2B}” may be satisfied. The ratio “M_{1B}/M_{2B}” may be, for example, 1.2 or more, 1.5 or more, 2 or more, or 2.5 or more. The ratio “M_{1B}/M_{2B}” may be, for example, 3 or less or 2 or less.

For example, a binder layer 3 may be formed between the first layer 1 and the second layer 2. A mass fraction of the binder in the binder layer 3 is higher than a mass fraction of the binder in the first layer 1 and the second layer 2. The binder layer 3 may be a layer that substantially does not include a negative electrode active material. The binder layer 3 may include, for example, in terms of mass fraction, 0% to 10% of a conductive material and the remaining binder. The binder layer 3 may include, for example, in terms of mass fraction, 1% to 5% of a conductive material and the remaining binder. For example, the type of the binder may be the same between the layers. For example, the type of the binder may be different between the layers. For example, the binder in the binder layer 3 may include a resin that swells with an electrolytic solution. For example, the binder in the binder layer 3 may include a resin having ion permeability or a resin having ion conductivity. It is expected that the charge rate characteristics are improved by allowing the electrolytic solution and the Li ions to permeate the binder layer 3. For example, the binder in the binder layer 3 may include a fibrous resin. The fibrous resin may extend to crosslink the first layer 1 and the second layer 2. By crosslinking the first layer 1 and the second layer 2 with the fibrous resin, for example, an improvement in peel strength is expected. The binder in the binder layer 3 may include, for example, at least one selected from the group consisting of the following. The group consists of PAA, polyacrylic acid ester, CMC, alginic acid, polyvinylidene fluoride (PVDF), poly(vinylidene fluoride-co-hexafluoropropylene) (PVDF-HFP), and PTFE. For example, PAA, PVDF, PVDF-HFP, and the like may have swellability, ion permeability, or ion conductivity. For example, PTFE may be fibrous.

The thickness “T₃” of the binder layer 3 may be, for example, smaller than the thickness “T₁” of the first layer 1 and the thickness “T₂” of the second layer 2. The thickness “T₃” of the binder layer 3 may be, for example, 10 μm or less, 5 μm or less, or 3 μm or less. The thickness “T₃” of the binder layer 3 may be, for example, 0.5 μm or more, 1 μm or more, or 3 μm or more. The basis weight “W₃” of the binder layer 3 may be, for example, smaller than the basis weight “W₁” of the first layer 1 and the basis weight “W₂” of the second layer 2. The basis weight “W₃” of the binder layer 3 may be, for example, 5 mg/cm² or less, 3 mg/cm² or less, or 1 mg/cm² or less. The basis weight “W₃” of the binder layer 3 may be, for example, 0.1 mg/cm² or more or 0.5 mg/cm² or more.

### Conductive Material

The conductive material may include, for example, acetylene black, carbon nanotube (CNT), and vapor-grown carbon fiber (VGCF). The mass fraction of the conductive material may be substantially constant over the entire region of the negative electrode active material layer 22. The mass fraction of the conductive material may be locally different. For example, the mass fraction of the conductive material may be different between the layers. For example, the type of the conductive material may be different between the layers. For example, the binder layer 3 may include a fibrous conductive material. The binder layer 3 may include, for example, at least one selected from the group consisting of CNT and VGCF. The fibrous conductive material may extend to crosslink the first layer 1 and the second layer 2. By crosslinking the first layer 1 and the second layer 2 with the fibrous conductive material, for example, an improvement in charge rate characteristics and an improvement in peel strength are expected.

What is claimed is:

1. A negative electrode for a non-aqueous electrolyte secondary battery, the negative electrode comprising:
a negative electrode collector; and
a negative electrode active material layer, wherein:
the negative electrode active material layer is disposed on a surface of the negative electrode collector,
the negative electrode active material layer includes a first layer and a second layer,
the first layer is disposed between the negative electrode collector and the second layer,
the negative electrode active material layer contains artificial graphite, natural graphite, and a Si-based active material as a negative electrode active material,
a mass fraction of the artificial graphite in the first layer is higher than a mass fraction of the artificial graphite in the second layer,
a mass fraction of the natural graphite in the first layer is lower than a mass fraction of the natural graphite in the second layer, and
a mass fraction of the Si-based active material in the first layer is higher than a mass fraction of the Si-based active material in the second layer.

2. The negative electrode according to claim 1, wherein:
the negative electrode active material layer further contains a binder, and
a mass fraction of the binder in the first layer is higher than a mass fraction of the binder in the second layer.

3. The negative electrode according to claim 2, wherein:
the negative electrode active material layer further contains a binder layer,
the binder layer is disposed between the first layer and the second layer, and
a mass fraction of the binder in the binder layer is higher than a mass fraction of the binder in the first layer and the second layer.

4. The negative electrode according to claim 1, wherein a void ratio of the first layer is higher than a void ratio of the second layer.

5. A negative electrode for a non-aqueous electrolyte secondary battery, the negative electrode comprising:
a negative electrode collector; and
a negative electrode active material layer, wherein:
the negative electrode active material layer is disposed on a surface of the negative electrode collector,
the negative electrode active material layer includes a first layer, a second layer, and a binder layer,
the first layer is disposed between the negative electrode collector and the second layer,
the negative electrode active material layer contains a negative electrode active material and a binder,
the negative electrode active material in the first layer consists of substantially artificial graphite and a Si-based active material,
the negative electrode active material in the second layer consists of substantially natural graphite,
the natural graphite has a larger aspect ratio than the artificial graphite,
a void ratio of the first layer is higher than a void ratio of the second layer,
a mass fraction of the binder in the first layer is higher than a mass fraction of the binder in the second layer,
the binder layer is disposed between the first layer and the second layer, and
a mass fraction of the binder in the binder layer is higher than a mass fraction of the binder in the first layer and the second layer.
